(19) United States
(12) Patent Application Publication
(10) Pub. No.: US 2017/0037765 A1
(43) Pub. Date: Feb. 9, 2017

(54) Exhaust Manifold

(71) Applicants: Robert W. Downes, IV, Wilmington, NC (US); Jacob B. Hershorin, Alexandria, VA (US)

(72) Inventors: Robert W. Downes, IV, Wilmington, NC (US); Jacob B. Hershorin, Alexandria, VA (US)

(21) Appl. No.: 15/227,019

(22) Filed: Aug. 3, 2016

Related U.S. Application Data
(60) Provisional application No. 62/200,478, filed on Aug. 3, 2015.

(51) Int. Cl. F01N 13/10; F02B 37/02; F01N 13/18

(52) U.S. Cl. CPC F01N 13/10; F01N 13/1805; F02B 37/02; F01N 2470/10

(57) ABSTRACT

The disclosure relates to a system and method for an exhaust manifold.

### CROSS REFERENCE TO RELATED APPLICATION

The present application claims priority to and the benefit of U.S. Patent Application No. 62/200,478, “Exhaust Manifold” (filed Aug. 3, 2015), the entirety of which is incorporated herein for any and all purposes.

### TECHNICAL FIELD

This disclosure relates generally to an exhaust system, and more particularly, to a system and apparatus for an exhaust manifold and a method for manufacturing and installing the exhaust manifold.

### BACKGROUND

In automobiles, an exhaust manifold collects exhaust gases that are produced from multiple cylinders of an engine. The exhaust manifold transfers the exhaust gases to an exhaust pipe that transfers the gases to the atmosphere.

### SUMMARY

An exhaust manifold for attachment to an internal combustion engine is provided. The exhaust manifold generally includes a first manifold, a second manifold portion, and an exhaust flange. The first manifold portion has a first divider. The second manifold portion has a second divider. The second manifold portion is coupled to the first manifold portion such that the first divider and the second divider are aligned. The first manifold portion and the second manifold portion define a first plurality of ports and a second plurality of ports. The first plurality of ports is fluidly separated from the second plurality of ports by the first divider and the second divider. The exhaust flange is coupled to the first manifold portion and the second manifold portion, the exhaust flange including a third divider aligned with the first divider and the second divider. A first fluid channel is formed that extends through the manifold from the first plurality of ports to the exhaust flange. A second fluid channel is formed that extends through the manifold from the second plurality of ports to the exhaust flange.

Another aspect of the present disclosure provides a method of manufacturing an exhaust manifold. The method includes holding and machining a first manifold portion and a second manifold portion simultaneously. The first manifold portion has a first divider and a first plurality of channels, the second manifold portion has a second divider and a second plurality of channels. The second divider is configured to align with the first divider and the second plurality of channels is configured to align with the first plurality of channels. The method further includes holding and machining an exhaust flange having a third divider. The method further includes coupling the first manifold portion to the second manifold portion such that the first divider is aligned with the second divider. The method further includes coupling the exhaust flange to the first manifold portion and the second manifold portion such that the third divider is aligned with the first divider and the second divider.

Another aspect of the present disclosure provides a method of installing an exhaust manifold. The method includes placing at least one manifold gasket on each of a first plurality of ports and a second plurality of ports. The first plurality of ports and the second plurality of ports are defined by a first manifold portion that has a first divider and a second manifold portion that has a second divider. The second manifold portion is coupled to the first manifold portion such that the first divider and the second divider are aligned. The first plurality of ports is fluidly separated from the second plurality of ports by the first divider and the second divider. The method further includes hanging each of the at least one manifold gaskets from studs on the engine. The method further includes tightening each of the at least one manifold gaskets to the studs. The method further includes attaching a turbocharger to an exhaust flange. The exhaust flange is coupled to the first manifold portion and the second manifold portion. The exhaust flange includes a third divider aligned with the first divider and the second divider. A first fluid channel is formed that extends through the manifold from the first plurality of ports to the exhaust flange and a second fluid channel is formed that extends through the manifold from the second plurality of ports to the exhaust flange.

### BRIEF DESCRIPTION OF THE DRAWINGS

FIG. 1 is a view of an exhaust manifold, according to an aspect of this disclosure.

FIG. 2 is a view of a first portion of the exhaust manifold shown in FIG. 1, according to an aspect of this disclosure.

FIG. 3 is a view of a second portion of the exhaust manifold shown in FIG. 1, according to an aspect of this disclosure.

FIG. 4 is a view of a third portion of the exhaust manifold shown in FIG. 1, according to an aspect of this disclosure.

FIG. 5 is a view of a fourth portion of the exhaust manifold shown in FIG. 1, according to an aspect of this disclosure.

FIG. 6 is a view of a fifth portion of the exhaust manifold shown in FIG. 1, according to an aspect of this disclosure.

### DETAILED DESCRIPTION

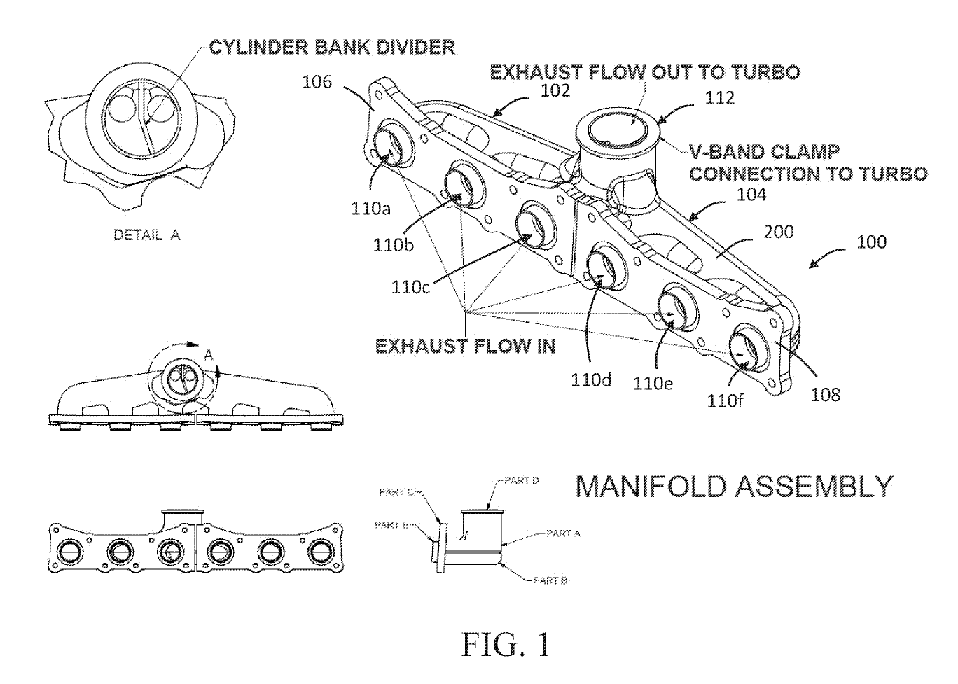

FIG. 1 shows an exhaust manifold assembly 100 which can be attached to an internal combustion engine, according to an aspect of this disclosure. In particular, the exhaust manifold assembly 100 may be attached to motor vehicles with cylinders arranged in at least one line (in-line combustion engine or cylinder bank of a V-engine).

The exhaust manifold assembly 100 may be a multi-banked manifold, in the illustrated case two banks are present, a first bank 102 and a second bank 104. The first bank 102 and the second bank 104 compose the manifold body member 200. Each bank 102, 104 includes three ports 110a-c and 110d-f, respectively. Each of the ports 110a-c, 110d-f correspond to a single cylinder of an engine. Each bank 102, 104 is therefore connected to three engine cylinders thereby dividing the engine in two sections of three cylinders. In an aspect, each set of the three cylinders are adjacent to each other.

The two banks 102, 104 may have a first support bank piece 106 and a second support bank piece 108, respectively. Each support bank piece 106, 108 may be configured to support each of the ports 110a-c and 110d-f, such that movement of the ports 110a-c and 110d-f relative to each other is minimized.

At a downstream end of the exhaust manifold 100 there is an exhaust flange 112 that allows for connection to a turbocharger (not shown). Each of the banks 102, 104 may not allow any mixing of gas within the exhaust manifold 100 except via the exhaust flange 112.

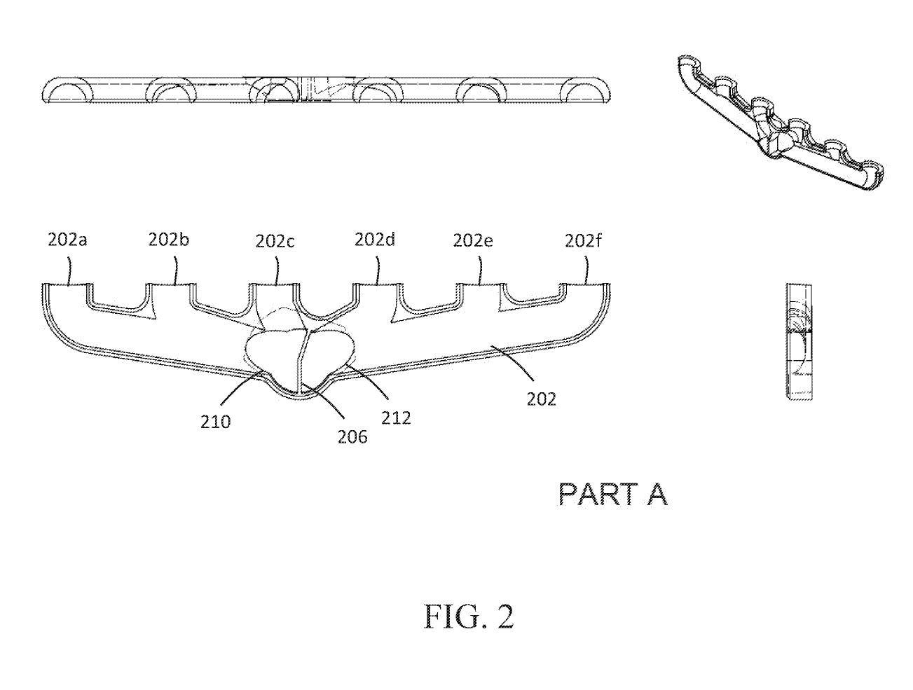

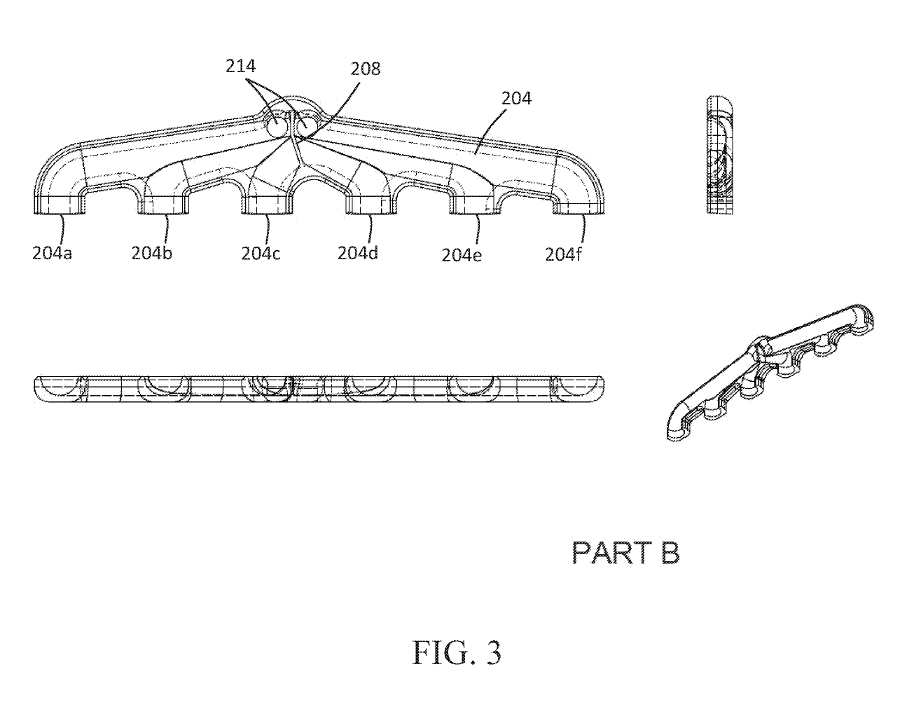

FIGS. 2 and 3 illustrate a first manifold portion 202 and a second manifold portion 204, respectively. The first manifold portion 202 is configured to align with the second manifold portion 204 to form the manifold body member 200, which defines the first bank 102 and the second bank 104. The first manifold portion 202 includes six channels 202a-f, and the second manifold portion 204 includes six channels 204a-f. When the first manifold portion 202 is aligned with the second manifold portion 204, channels 202a-f and channels 204a-f align forming the ports 110a-f.

The first manifold portion 202 further includes a first cylinder bank divider 206 and the second manifold portion 204 includes a second cylinder bank divider 208. When the first manifold portion 202 is aligned with the second manifold portion 204, the first cylinder bank divider 206 aligns with the second cylinder bank divider 208 such that fluid communication between the first bank 102 and the second bank 104 is substantially restricted.

The first manifold portion 202 defines a first manifold opening 210 and a second manifold opening 212. Each of the openings 210, 212 extend through the first manifold portion 202 and are separated by the first cylinder bank divider 206.

The second manifold portion 204 defines oxygen sensor mounts 214. Each of the sensor mounts may be positioned adjacent to the second cylinder bank divider 208.

The first manifold portion 202 may be coupled to the second manifold portion 204 by using bolts, welding, adhesives, or other coupling means known in the art.

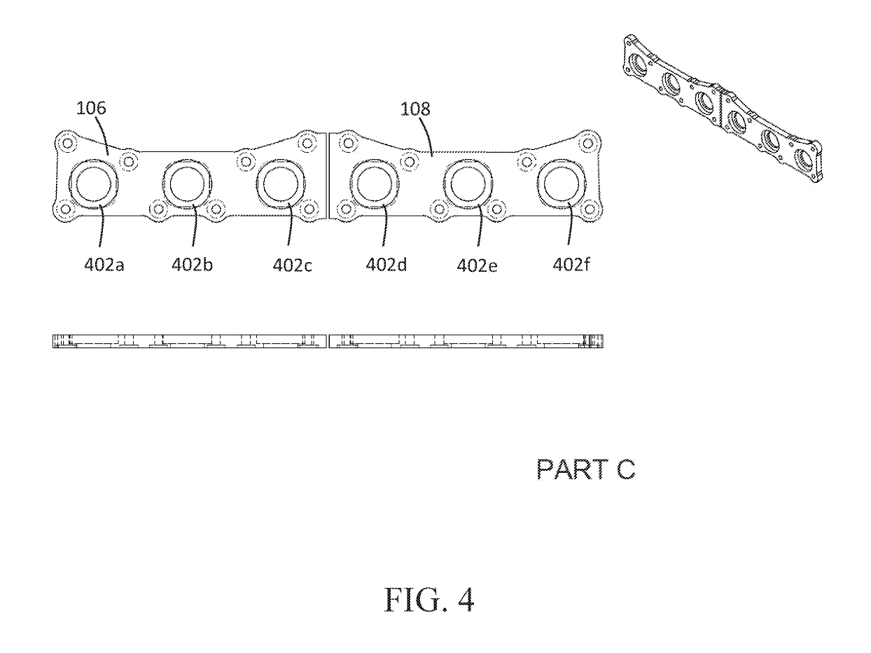

FIG. 4 illustrates the first support bank piece 106 and the second support bank piece 108, respectively, according to an aspect of this disclosure. Each of the support bank pieces 106, 108 may also include support bank openings 402a-c and 402d-f, respectively. Each of the support bank openings 402a-f are configured to receive the ports 110a-f of each bank 102, 104. Each of the support bank pieces 106, 108 may be coupled to the manifold body member 200.

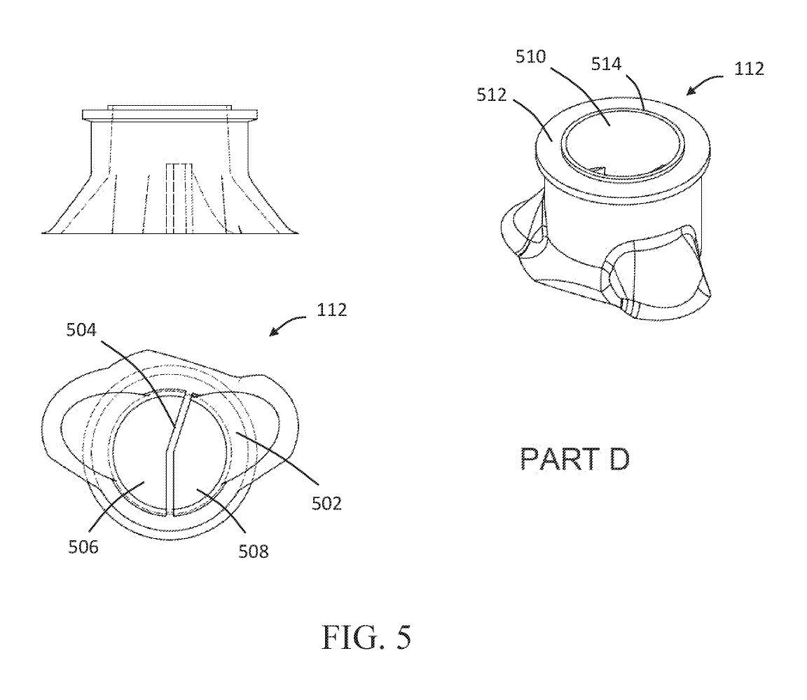

FIG. 5 illustrates the exhaust flange 112, according to an aspect of this disclosure. The exhaust flange 112 includes an exhaust flange body member 502, an exhaust flange bank divider 504, and a clamp 512. The clamp 512 may be configured to connect to a conduit (not shown) to fluidly connect exhaust gas from the exhaust flange 112 to a turbocharger. The exhaust flange 112 defines a first flange channel 506, a second flange channel 508, and a third flange channel 510. The first flange channel 506 is separated from the second flange channel 508 by the exhaust flange bank divider 504. The first flange channel 506 is in fluid communication with the third flange channel 510, which forms a fourth flange channel (not labelled) that extends through the flange body member 502. The second flange channel 508 is in fluid communication with the third flange channel 510, which forms a fifth flange channel (not labelled) that extends through the flange body member 502. The fourth flange channel and the fifth flange channel extend from the first flange channel 506 and the second flange channel 508, respectively, to a flange exhaust opening 514.

The exhaust flange 112 may be coupled to the first manifold portion 202 of the manifold body member 200 such that the exhaust flange bank divider 504 aligns with the first cylinder bank divider 206. The alignment of the exhaust flange bank divider 504 with the first cylinder bank divider 206 may form a fluid connection between the first bank 102 and the first flange channel 506 and a fluid connection between the second bank 104 and the second flange channel 508, thereby fluidly connecting each of the banks 102, 104 with the flange exhaust opening 514.

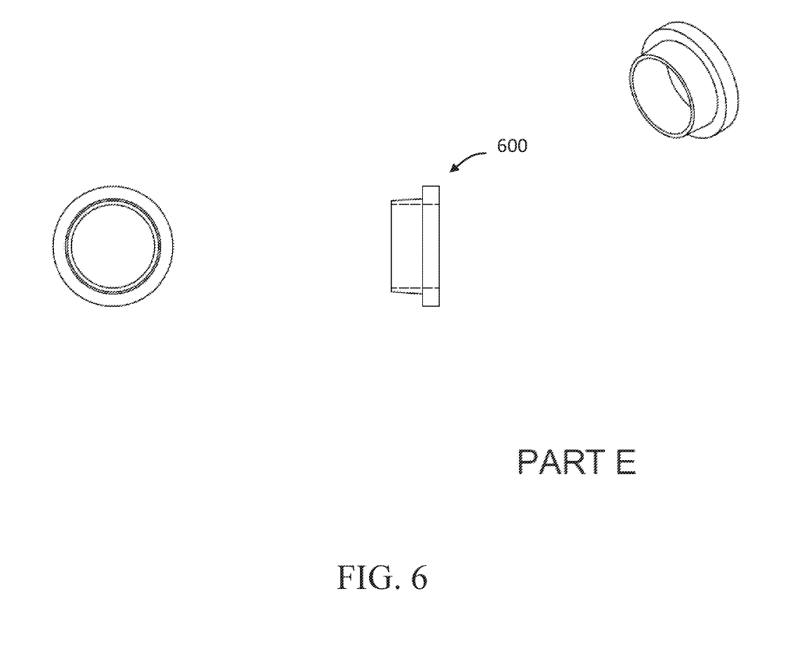

FIG. 6 illustrates a sealing port 600, according to an aspect of this disclosure. The sealing port 600 is configured to fit within one of the support bank openings 402a-f. In an aspect of this disclosure, there are 6 sealing ports 600, each positioned within one of the support bank openings 402a-f. Each sealing port 600 may be coupled to a corresponding support bank opening 402a-f, or each sealing port 600 may be coupled directly to the manifold body member 200 at each of the corresponding ports 110a-f.

To install the exhaust manifold 100 to an engine block (not shown), for example, a BMW N54 engine block, the factory system is first removed. This may involve removing the original equipment manufacturer (OEM) turbochargers from the engine block. Once the turbocharges are removed, clean all the surfaces and make sure that everything is as clean as possible. Using new exhaust manifold gaskets (not shown), place one on each of the ports 110a-f and hang it from studs (not shown) on the engine block. Use new nuts (i.e. BMW nuts that typically come with the gaskets as a set) and loosely finger tighten them onto the engine block studs. Follow the factory torque-down pattern to ensure the exhaust manifold 100 secures down flat and/or true to the engine block. A single turbocharger and related hardware is then similarly mounted to the flange exhaust opening 514 of the exhaust manifold 100.

An example of a method of manufacturing the exhaust manifold 100 may include the following steps:
Hold and machine raw material for first manifold portion 202 and the second manifold portion 204 simultaneously in a computer numerical control (CNC) milling machine. This includes machine channels for exhaust airflow, the first cylinder bank divider 206, the second cylinder bank divider 208, oxygen sensor mounts 214, and pins (not labelled) for aligning the first manifold portion 202 and a second manifold portion 204.
Hold and machine raw material for the first support bank piece 106 and the second support bank piece 108 in a CNC milling machine. Machine ports for the exhaust airflow from the cylinder head, machine mounting holes to affix to the cylinder head, machine recesses for the sealing ports 600.
Hold and machine raw material for the exhaust flange 112 in a CNC lathe machine. This includes the exhaust flange bank divider 504, the first flange channel 506, the second flange channel 508, and the third flange channel 510, and the clamp 512.
Hold and machine raw material for the sealing port 600 in a CNC lathe machine. Machine taper for sealing using OEM gasket ring and interior port for exhaust flow.
Assemble the first manifold portion 202 and the second manifold portion 204 using alignment pins (not shown) and tungsten inert gas (TIG) weld to form the manifold body member 200.
Assemble the exhaust flange 112 to the manifold body member 200 and couple with a TIG weld.
Assemble the first support bank piece 106 and the second support bank piece 108 to the previously assembled parts (the manifold body member 200 and the exhaust flange 112) and couple with a TIG weld
Assemble the sealing port 600 to the previously assemble parts (the exhaust flange 112, the manifold body member 200, and the exhaust flange 112) and couple with a TIG weld.

All references to the disclosure or examples thereof are intended to reference the particular example being discussed at that point and are not intended to imply any limitation as to the scope of the disclosure more generally. The scope of the protected innovation is defined by the attached claims.

What is claimed:

1. A manifold assembly comprising:
a first manifold portion having a first divider;
a second manifold portion having a second divider, the second manifold portion coupled to the first manifold portion such that the first divider and the second divider are aligned, wherein the first manifold portion and the second manifold portion define a first plurality of ports and a second plurality of ports, wherein the first plurality of ports is fluidly separated from the second plurality of ports by the first divider and the second divider; and
an exhaust flange coupled to the first manifold portion and the second manifold portion, the exhaust flange including a third divider aligned with the first divider and the second divider,
wherein a first fluid channel is formed that extends through the manifold from the first plurality of ports to the exhaust flange, and wherein a second fluid channel is formed that extends through the manifold from the second plurality of ports to the exhaust flange.

2. A method of manufacturing a manifold comprising:
holding and machining a first manifold portion and a second manifold portion simultaneously, the first manifold portion having a first divider and a first plurality of channels, the second manifold portion having a second divider and a second plurality of channels, the second divider configured to align with the first divider and the second plurality of channels configured to align with the first plurality of channels;
holding and machining an exhaust flange having a third divider;
coupling the first manifold portion to the second manifold portion such that the first divider is aligned with the second divider;
coupling the exhaust flange to the first manifold portion and the second manifold portion such that the third divider is aligned with the first divider and the second divider.

3. A method of installing a manifold to an engine comprising:
placing at least one manifold gasket on each of a first plurality of ports and a second plurality of ports, wherein the first plurality of ports and the second plurality of ports are defined by a first manifold portion having a first divider and a second manifold portion having a second divider, the second manifold portion is coupled to the first manifold portion such that the first divider and the second divider are aligned, wherein the first plurality of ports is fluidly separated from the second plurality of ports by the first divider and the second divider;
hanging each of the at least one manifold gaskets from studs on the engine;
tightening each of the at least one manifold gaskets to the studs; and
attaching a turbocharger to an exhaust flange, the exhaust flange coupled to the first manifold portion and the second manifold portion, the exhaust flange including a third divider aligned with the first divider and the second divider, wherein a first fluid channel is formed that extends through the manifold from the first plurality of ports to the exhaust flange, and wherein a second fluid channel is formed that extends through the manifold from the second plurality of ports to the exhaust flange.
